(19) United States
(12) Patent Application Publication
(10) Pub. No.: US 2025/0384730 A1
(43) Pub. Date: Dec. 18, 2025

(54) Lottery-Ticket Issuing Device and Lottery-Ticket Vending Machine

(71) Applicant: Shandong New Beiyang Information Technology Co., Ltd., Shandong (CN)

(72) Inventors: Dezhi Zhou, Shandong (CN); Tianxin Jiang, Shandong (CN); Bo Liu, Shandong (CN); Jiabo Xu, Shandong (CN)

(21) Appl. No.: 18/877,481

(22) PCT Filed: Jun. 21, 2023
(86) PCT No.: PCT/CN2023/101677

§ 371 Date: Dec. 20, 2024

(30) Foreign Application Priority Data
Jun. 24, 2022 (CN) 202210730066.0

(51) Int. Cl. G07C 15/00; G07B 3/04

(52) U.S. Cl. CPC G07C 15/005; G07B 3/04

(57) ABSTRACT

A lottery-ticket issuing device includes a ticket issuing mechanism and a ticket receiving mechanism. The ticket issuing mechanism includes a first base frame and a conveyance assembly disposed on the first base frame. The first base frame has a ticket issuing channel, and the conveyance assembly is configured to drive lottery-tickets to move along the ticket issuing channel. The ticket receiving mechanism includes a second base frame connected to the first base frame. The second base frame has a ticket receiving cavity communicating with the ticket issuing channel. The ticket receiving cavity has a guide surface and a supporting surface. The guide surface is configured to guide the lottery-tickets output from the ticket issuing channel to change a movement direction, so that the lottery-tickets are stacked on the supporting surface in a direction at an angle from a vertical direction.

The present application claims priority to Chinese Patent Application No. 202210730066.0, filed with the China National Intellectual Property Administration (CNIPA) on Jun. 24, 2022, the disclosure of which is incorporated herein by reference in its entirety.

### TECHNICAL FIELD

The present application relates to the field of self-service devices, for example, a lottery-ticket issuing device and a lottery-ticket vending machine.

### BACKGROUND

A lottery-ticket issuing device provided in the related art is used for issuing lottery-tickets. The lottery-ticket issuing device includes a ticket issuing mechanism and a ticket receiving mechanism. The ticket issuing mechanism is used for outputting the lottery-tickets. The ticket receiving mechanism is disposed below the ticket issuing mechanism. Lottery-tickets horizontally output by the ticket issuing mechanism are dropped freely into the ticket receiving mechanism, and multiple lottery-tickets dropped into the ticket receiving mechanism are stacked on a bottom wall of the ticket receiving mechanism in a vertical direction, whereby the purchaser can take out the lottery-tickets supported by the bottom wall.

Generally, in order to improve the regularity of the stacking of the lottery-tickets within the ticket receiving mechanism, a size of the bottom wall of the ticket receiving mechanism of the lottery-ticket issuing device provided in the related art in a horizontal direction needs to be greater than the length of the lottery-tickets. However, this results in a relatively large space being occupied by the ticket receiving mechanism in the horizontal direction, making it difficult to stack the lottery-tickets neatly when the size of the ticket issuing device in the horizontal direction is limited.

### SUMMARY

The present application provides a lottery-ticket issuing device and a lottery-ticket vending machine in which lottery-tickets can be stacked on a ticket receiving mechanism in a direction at an angle from a vertical direction, so that a size of space occupied by the lottery-ticket issuing device in a horizontal direction can be reduced, and when the size of the lottery-ticket issuing device in the horizontal direction is limited, the regularity of the stacking of the lottery-tickets can be ensured, thereby ensuring the efficient execution of an issuing operation of the lottery-tickets.

In a first aspect, an embodiment of the present application provides a lottery-ticket issuing device. The lottery-ticket issuing device includes a ticket issuing mechanism and a ticket receiving mechanism. The ticket issuing mechanism includes a first base frame and a conveyance assembly disposed on the first base frame, where the first base frame has a ticket issuing channel, and the conveyance assembly is configured to drive lottery-tickets to move along the ticket issuing channel. The ticket receiving mechanism includes a second base frame connected to the first base frame, where the second base frame has a ticket receiving cavity communicating with the ticket issuing channel, the ticket receiving cavity has a guide surface and a supporting surface, and the guide surface is configured to guide the lottery-tickets output from the ticket issuing channel to change a movement direction, so that the lottery-tickets are stacked on the supporting surface in a direction at an angle from a vertical direction.

In a second aspect, an embodiment of the present application provides a lottery-ticket vending machine. The lottery-ticket vending machine includes a cabinet, a ticket exit device, and the lottery-ticket issuing device described in the preceding embodiments. The cabinet is provided with a ticket pickup port for outputting a lottery-ticket. The ticket exit device is disposed within the cabinet and is configured to store and output the lottery-ticket. The lottery-ticket issuing device is movably disposed within the cabinet and has a ticket receiving position and a ticket pickup position, when the lottery-ticket issuing device is located in the ticket receiving position, the ticket issuing mechanism is capable of being opposite to the ticket exit device to receive the lottery-ticket output by the ticket exit device; when the lottery-ticket issuing device is located in the ticket pickup position, the ticket receiving mechanism is opposite to the ticket pickup port to output the lottery-ticket within the ticket receiving cavity through the ticket pickup port.

In a third aspect, an embodiment of the present application provides a lottery-ticket vending machine. The lottery-ticket vending machine includes a cabinet, a ticket exit device, the lottery-ticket issuing device described in the preceding embodiments, and a recycling box. The cabinet is provided with a ticket pickup port for outputting a lottery-ticket. The ticket exit device is disposed within the cabinet and is configured to store and output the lottery-ticket. The lottery-ticket issuing device is disposed within the cabinet, the ticket issuing mechanism is configured to receive the lottery-ticket output by the ticket exit device, and the ticket receiving cavity is capable of communicating with the ticket pickup port to output the lottery-ticket through the ticket pickup port. The recycling box is disposed within the cabinet and has a recycling port, where the recycling port is capable of communicating with a recycling channel to receive the lottery-ticket output by the recycling channel.

### BRIEF DESCRIPTION OF DRAWINGS

The drawings that are required to be used in embodiments are described hereinafter. It is to be understood that the following drawings merely show some embodiments of the present application. For those of ordinary skill in the art, other relevant drawings may also be obtained without creative labor according to these drawings.

FIG. 1 is a schematic structural diagram one of a lottery-ticket vending machine according to an embodiment of the present application;

FIG. 2 is a schematic structural diagram two of a lottery-ticket vending machine according to an embodiment of the present application;

FIG. 3 is a schematic diagram showing a partial structure of a lottery-ticket vending machine according to an embodiment of the present application;

FIG. 4 is a cross-sectional schematic diagram of a lottery-ticket issuing device according to an embodiment of the present application;

FIG. 5 is a schematic structural diagram one of a ticket receiving mechanism of a lottery-ticket issuing device according to an embodiment of the present application;

FIG. 6 is a schematic structural diagram two of a ticket receiving mechanism of a lottery-ticket issuing device according to an embodiment of the present application;

FIG. 7 is a partial exploded schematic diagram of a ticket issuing mechanism of a lottery-ticket issuing device according to an embodiment of the present application;

FIG. 8 is a schematic structural diagram of a cutting assembly of a lottery-ticket issuing device according to an embodiment of the present application;

FIG. 9 is a cross-sectional schematic diagram of a ticket issuing mechanism of a lottery-ticket issuing device according to another embodiment of the present application;

FIG. 10 is an enlarged partial view of area I of FIG. 1;

FIG. 11 is an enlarged partial view of area II of FIG. 3; and

FIG. 12 is an enlarged partial view of area III of FIG. 4.

### List of Reference Numbers

100 lottery-ticket issuing device
101 ticket issuing mechanism
103 ticket receiving mechanism
105 first base frame
107 second base frame
109 lottery-ticket
111 first channel plate
113 second channel plate
115 ticket issuing channel
116 conveyance assembly
117 first conveyance roller
119 second conveyance roller
121 transparent plate
122 identification member
125 cutting assembly
127 blade
129 cutting motor
131 guide surface
133 supporting surface
135 first surface
137 second surface
139 ticket receiving cavity
141 input port
143 ticket exit port
145 box body
147 door body
149 first plate
151 second plate
153 third plate
155 fourth plate
156 fifth plate
157 output port
159 elongated hole
161 notch
163 hanging hook
165 hanging plate
166 reversing member
167 first guide surface
168 second guide surface
169 third guide surface
171 fourth guide surface
172 pivot shaft
173 ticket entry channel
175 recycling channel
179 spring
181 supporting protrusion
182 first fixing plate
183 second fixing plate
184 guide shaft
185 compression spring
186 transmission wheel
187 supporting plate
188 guide sleeve
189 cam
190 connection member
191 first guide plate
192 second guide plate
193 first warehouse wall
194 second warehouse wall
195 first channel segment
196 second channel segment
200 lottery-ticket vending machine
201 cabinet
202 cabinet body
203 cabinet door
204 banknote receiving device
205 barcode scanning device
206 printing device
207 gate
208 ticket pickup port
209 certificate card identification device
211 vertical beam
213 cross beam
214 open port
215 recycling box
217 recycling port
218 ticket exit device
220 ticket warehouse
221 accommodation cavity
223 first limiting member
225 second limiting member
226 ticket exit mechanism
227 ticket entry port

### DETAILED DESCRIPTION

Embodiments of the present application will be described below in conjunction with the accompanying drawings of the embodiments of the present application, the described embodiments are merely part of the embodiments of the present application, rather than all of the embodiments of the present application.

Therefore, the following description of the embodiments of the present application provided in the accompanying drawings is not intended to limit the scope of the present application as claimed, but is merely representative of selected embodiments of the present application. All other embodiments obtained by those of ordinary skill in the art based on the embodiments of the present application without requiring creative efforts shall all fall within the scope of protection of the present application.

It is to be noted that like reference numbers and letters refer to like items in the following accompanying drawings, and thus, once an item is defined in one accompanying drawing, this item need not be further defined or explained in subsequent accompanying drawings.

In the description of the present application, it is to be noted that orientations or position relations indicated by terms such as “center”, “upper”, “lower”, “left”, “right”, “vertical”, “horizontal”, “inner” and “outer” are based on orientations or position relations shown in the accompanying drawings, or orientations or position relations of the products of the present application which are usually placed when in use. These orientations or position relations are intended only to facilitate and simplify the description of the present application and not to indicate or imply that an apparatus or element referred to must have such particular orientations or must be configured or operated in such particular orientations. Moreover, terms such as “first”, “second” and “third” are used only for distinguishing descriptions and are not to be construed as indicating or implying relative importance.

Furthermore, terms such as “horizontal” and “vertical” do not imply that the parts are required to be absolutely horizontal or pendant, but rather may be slightly tilted. For example, “horizontal” merely means that the direction thereof is more horizontal relative to “vertical”, and does not mean that the structure must be completely horizontal, but may be slightly inclined.

In the description of the present application, it is also to be noted that terms “disposed”, “mounted”, “joined” and “connected” are to be understood in a broad sense unless otherwise expressly specified and limited. For example, the term “connected” may refer to “fixedly connected” or “detachably connected” or “integrally connected”, may refer to “mechanically connected” or “electrically connected”, or may refer to “connected directly”, “connected indirectly through an intermediary” or “connected inside two components”. For those of ordinary skill in the art, meanings of the preceding terms in the present application may be understood based on situations.

In the related art, a lottery-ticket issuing device includes a ticket issuing mechanism and a ticket receiving mechanism. The ticket issuing mechanism is used for outputting a lottery-ticket. The ticket receiving mechanism is disposed below the ticket issuing mechanism. Lottery-tickets horizontally output by the ticket issuing mechanism are dropped freely into the ticket receiving mechanism, and multiple lottery-tickets dropped into the ticket receiving mechanism are stacked on a bottom wall of the ticket receiving mechanism in a vertical direction, under the action of gravity, a front end of a lottery-ticket of the multiple lottery-tickets firstly contacts the bottom wall before a rear end of a lottery-ticket of the multiple lottery-tickets contacts the bottom wall, which results in that the multiple lottery-tickets cannot be stacked neatly on the bottom wall. In order to improve the regularity of the stacking of the lottery-tickets within the ticket receiving mechanism, a size of the bottom wall of the ticket receiving mechanism of the lottery-ticket issuing device provided in the related art in a horizontal direction needs to be greater than the length of the lottery-ticket, however, this results in a relatively large space occupied by the ticket receiving mechanism in the horizontal direction, so that when the size of the lottery-ticket issuing device in the horizontal direction is limited, it is difficult for the lottery-tickets to be stacked on the ticket receiving mechanism neatly.

In view of this, this embodiment provides a lottery-ticket issuing device 100 and a lottery-ticket vending machine 200 in which lottery-tickets 109 can be stacked on a ticket receiving mechanism 103 in a direction at an angle from a vertical direction, so that a size of space occupied by the lottery-ticket issuing device 100 in a horizontal direction can be reduced, and when the size of the lottery-ticket issuing device 100 in the horizontal direction is limited, the regularity of the stacking of the lottery-tickets 109 can still be ensured, thereby ensuring the efficient execution of an issuing operation of the lottery-tickets 109. The structures of the lottery-ticket issuing device 100 and the lottery-ticket vending machine 200 will be described below.

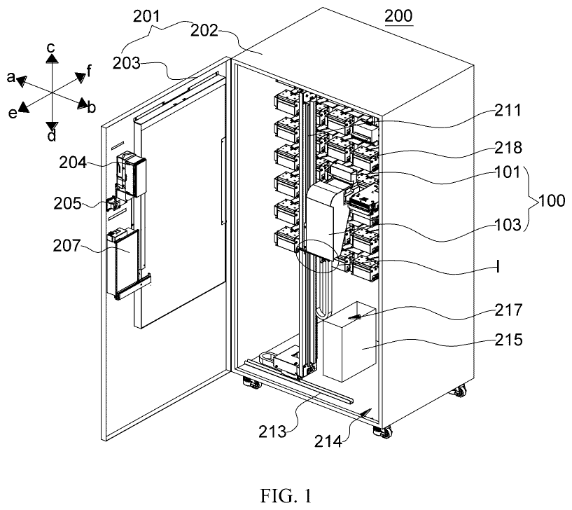

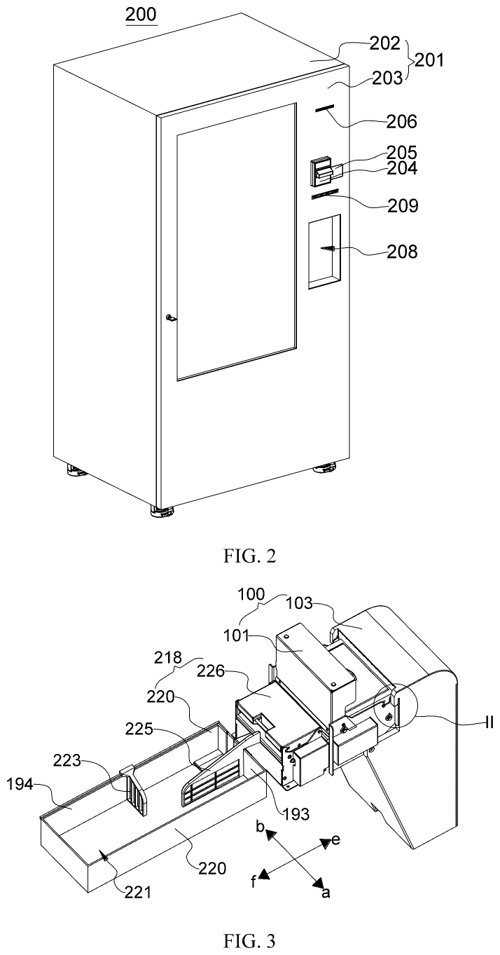

FIG. 1 is a schematic structural diagram one of a lottery-ticket vending machine 200 according to an embodiment of the present application; FIG. 2 is a schematic structural diagram two of a lottery-ticket vending machine 200 according to an embodiment of the present application; and FIG. 3 is a schematic diagram showing a partial structure of a lottery-ticket vending machine 200 according to an embodiment of the present application. Referring to FIGS. 1 to 3, the lottery-ticket vending machine 200 provided in this embodiment includes a cabinet 201, a ticket exit device 218 and a lottery-ticket issuing device 100.

The cabinet 201 is a rectangular parallelepiped cabinet-shaped structure. The cabinet 201 may include a cabinet body 202 and a cabinet door 203. The cabinet body 202 is a rectangular parallelepiped structure having an open port 214. The cabinet door 203 is movably disposed at the open port 214 of the cabinet body 202. Exemplarily, the cabinet door 203 may be pivotally connected to the cabinet body 202, or the cabinet door 203 may be slidably fitted with the cabinet body 202. The cabinet door 203 may move relative to the cabinet body 202 to open or close the open port 214. When the cabinet door 203 opens the open port 214, a merchant may replenish the lottery-tickets 109 in the cabinet body 202 or may perform maintenance operations such as replacement and inspection on structures within the cabinet 201. When the cabinet door 203 closes the open port 214, the lottery-ticket vending machine 200 is capable of performing a normal ticket vending operation so that a user can take away the lottery-ticket 109. Moreover, in order to facilitate the user in taking away the lottery-ticket 109, the cabinet 201 is further provided with a ticket pickup port 208, and a gate 207 is disposed at the ticket pickup port 208. When a ticket exit operation is performed, the gate 207 may communicate the ticket pickup port 208 with the inside of the cabinet 201, so that the user can take away the lottery-ticket 109 through the ticket pickup port 208. When a ticket exit operation is not performed, the gate 207 seals the ticket pickup port 208 to prevent unauthorized persons from acquiring the lottery-ticket 109 in the cabinet 201 through the ticket pickup port 208. In this embodiment, the ticket pickup port 208 is disposed at the cabinet door 203, and the gate 207 is movably connected to the cabinet door 203; of course, in other embodiments, the ticket pickup port 208 may also be disposed on the cabinet body 202, and the gate 207 is movably connected to the cabinet body 202, so that the user can take away the lottery-ticket 109 through the ticket pickup port 208 conveniently.

The ticket exit device 218 and the lottery-ticket issuing device 100 are both disposed within the cabinet body 202. Exemplarily, the number of the ticket exit devices 218 may be set to be one or more, when multiple ticket exit devices 218 are provided, the multiple ticket exit devices 218 are arranged in N rows and M columns within the cabinet 201. Each ticket exit device 218 is configured to store the lottery-ticket 109 and output the lottery-ticket 109 to the lottery-ticket issuing device 100. Optionally, the multiple ticket exit devices 218 may store the same or different lottery-tickets 109, and the lottery-ticket issuing device 100 is configured to receive the lottery-ticket 109 output by the ticket exit device 218 and make the lottery-ticket 109 move to the ticket pickup port 208, so that the user can take away the lottery-ticket 109 within the lottery-ticket issuing device 100 through the ticket pickup port 208.

Exemplarily, in this embodiment, the lottery-ticket issuing device 100 is movably disposed within the cabinet 201, and the lottery-ticket issuing device 100 has a ticket receiving position and a ticket pickup position. When the lottery-ticket issuing device 100 is located in the ticket receiving position, the lottery-ticket issuing device 100 is opposite to the ticket exit device 218 to receive one or more lottery-tickets 109 output by the ticket exit device 218. Since multiple ticket exit devices 218 are provided in this embodiment, the lottery-ticket issuing device 100 has multiple ticket receiving positions in one-to-one correspondence with the multiple ticket exit devices 218. When the lottery-ticket issuing device 100 is located in the ticket pickup position, the lottery-ticket issuing device 100 may be opposite to the ticket pickup port 208, and the user may take away the lottery-ticket 109 issued by the lottery-ticket issuing device 100 through the ticket pickup port 208.

With such an arrangement, the lottery-ticket issuing device 100 may be moved to each ticket receiving position to receive the lottery-ticket 109 output from each ticket exit device 218, and the lottery-ticket issuing device 100 may also be moved between any one ticket receiving position of the ticket receiving positions and the ticket pickup position to deliver the lottery-ticket 109 to the ticket pickup port 208; therefore, the ticket pickup port 208 may be disposed at any height of the cabinet 201, thereby enabling the operator to take out the lottery-ticket 109 from the ticket pickup port 208 in a comfortable posture.

It is to be noted that, in order to ensure that the lottery-ticket issuing device 100 may be moved between any one ticket receiving position of the ticket receiving positions and the ticket pickup position, in this embodiment, a cross beam 213 and a vertical beam 211 are disposed within the cabinet 201, and a first driving mechanism and a second driving mechanism are also disposed within the cabinet 201. The cross beam 213 is disposed at a position adjacent to the open port 214 at the bottom or top of the cabinet body 202, the cross beam 213 extends in a left-and-right direction (the left-and-right direction is the horizontal direction and is also a direction indicated by an arrow ab in FIG. 1), the vertical beam 211 is disposed at a position adjacent to the open port 214 of the cabinet body 202, and the vertical beam 211 extends in an up-and-down direction (the up-and-down direction is a vertical direction and is also a direction indicated by an arrow cd in FIG. 1). The first driving mechanism is in transmission connection between the cross beam 213 and the vertical beam 211, and may drive the vertical beam 211 to move along the cross beam 213. The second driving mechanism is in transmission connection between the lottery-ticket issuing device 100 and the vertical beam 211 and may drive the lottery-ticket issuing device 100 to move along the vertical beam 211, that is, the first driving mechanism may move the lottery-ticket issuing device 100 in the left-and-right direction, and the second driving mechanism may move the lottery-ticket issuing device 100 in the up-and-down direction. With such an arrangement, the lottery-ticket issuing device 100 is moved in the left-and-right direction and the up-and-down direction, so that the lottery-ticket issuing device 100 may be opposite to any one ticket exit device of the multiple ticket exit devices 218 to acquire the lottery-ticket 109 output by this ticket exit device 218, and the lottery-ticket issuing device 100 may also be opposite to the ticket pickup port 208, so that the user can take away the lottery-ticket 109 issued by the lottery-ticket issuing device 100 through the ticket pickup port 208.

It is also to be noted that, in this embodiment, both the first driving mechanism and the second driving mechanism may be selected for a combination of a motor plus a gear assembly or a combination of a motor plus a transmission belt assembly. Moreover, an inserting groove extending in the left-and-right direction may be disposed on the cross beam 213, and the first driving mechanism may be inserted into the inserting groove through an inserting column to drive the vertical beam 211 to move in the left-and-right direction under the driving of the motor, so that the lottery-ticket issuing device 100 may be moved in the left-and-right direction. An inserting groove extending in the up-and-down direction may also be disposed on the vertical beam 211, and the second driving mechanism may also be inserted into the inserting groove through the inserting column, to drive the lottery-ticket issuing device 100 to move in the up-and-down direction under the driving of the motor. The structures of the first driving mechanism and the second driving mechanism may refer to the related art.

In addition, it is also to be noted that, in this embodiment, the lottery-ticket vending machine 200 further includes a controller, and the controller may be selected as a programmable logic controller, a single-chip microcomputer or a computer. The controller may control the movement of structures such as the ticket exit device 218, the lottery-ticket issuing device 100, the first driving mechanism, the second driving mechanism, and the gate 207. Exemplarily, when the ticket vending operation is performed, the controller may control the first driving mechanism and the second driving mechanism to drive the lottery-ticket issuing device 100 to move to be opposite to a target ticket exit device 218, may control the ticket exit device 218 to exit a ticket to the lottery-ticket issuing device 100, and then may control the lottery-ticket issuing device 100 to move towards the ticket pickup port 208, and may control the gate 207 to make the ticket pickup port 208 open, so that the user can take away the lottery-ticket 109 within the lottery-ticket issuing device 100 through the ticket pickup port 208.

Referring again to FIG. 3, in order to ensure that the ticket exit device 218 may output the lottery-ticket 109 to the lottery-ticket issuing device 100 efficiently, in this embodiment, the ticket exit device 218 may include a ticket warehouse 220 and a ticket exit mechanism 226. The ticket warehouse 220 has an accommodation cavity 221 for storing a lottery-ticket 109 to be sold. In an embodiment, the lottery-ticket 109 to be sold is multiple lottery-tickets which are sequentially connected one by one, and the multiple lottery-tickets may be wound into a roll or folded into a stack. In other embodiments, the lottery-ticket to be sold is multiple lottery-tickets which are mutually independent and stacked into a stack. In this embodiment, an example in which the multiple lottery-tickets are folded into a stack is described. A stack of lottery-tickets are stacked in the ticket warehouse 220, the ticket exit mechanism 226 includes two rotary rollers disposed opposite to each other, and the two rotary rollers are configured to clamp the lottery-ticket 109 led out from the ticket warehouse 220 and drive the lottery-ticket 109 to move to the lottery-ticket issuing device 100.

Moreover, in order to ensure the stability of the position of the lottery-ticket 109 within the ticket warehouse 220, a first limiting member 223 and a second limiting member 225 which may be movably connected to the ticket warehouse 220 may be disposed within the accommodation cavity 221 of the ticket warehouse 220 according to requirements. The first limiting member 223 extends in the left-and-right direction and may be moved relative to the ticket warehouse 220 in the front-back direction (the front-back direction is the horizontal direction and is also a direction indicated by an arrow ef in FIGS. 1 and 3). The second limiting member 225 extends in the front-rear direction and may be moved relative to the ticket warehouse 220 in the left-and-right direction (the left-and-right direction is the horizontal direction and is also a direction indicated by an arrow ab in FIGS. 1 and 3). By means of the arrangement of the first limiting member 223 and the second limiting member 225, the position of the lottery-ticket 109 within the accommodation cavity 221 may be jointly limited, to adapt to the lottery-tickets 109 of different sizes, thereby ensuring the stability of the position of the lottery-ticket 109 within the accommodation cavity 221, preventing the lottery-ticket 109 from moving around within the accommodation cavity 221, and fully improving the stability and reliability of the ticket exit operation.

Exemplarily, the ticket warehouse 220 is in a shape of a box body and includes a first warehouse wall 193 extending in the left-and-right direction and a second warehouse wall 194 extending in the front-rear direction, the first limiting member 223 and the second limiting member 225 are both provided with a snap-fit groove, the snap-fit groove on the first limiting member 223 is snap-fitted with the second warehouse wall 194, and the first limiting member 223 may slide along the second warehouse wall 194 to adjust a position of the first limiting member 223 in the front-rear direction. The snap-fit groove on the second limiting member 225 is snap-fitted with the first warehouse wall 193, and the second limiting member 225 may slide along the first warehouse wall 193 to adjust the position of the second limiting member 225 in the left and right direction. In other embodiments, the positions of the first limiting member 223 and the second limiting member 225 may also be adjusted by motors or other linear drive structures. Of course, in other embodiments, the first limiting member 223 may be connected to the ticket warehouse 220 in a sliding fit or an inserting fit manner, and the second limiting member 225 may be connected to the ticket warehouse 220 in the sliding fit or an inserting fit manner.

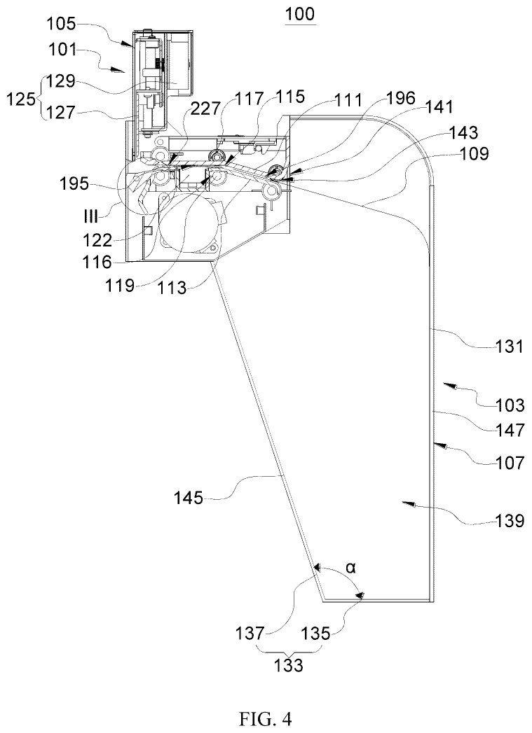

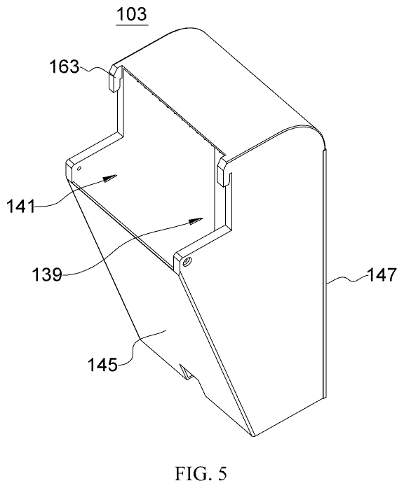

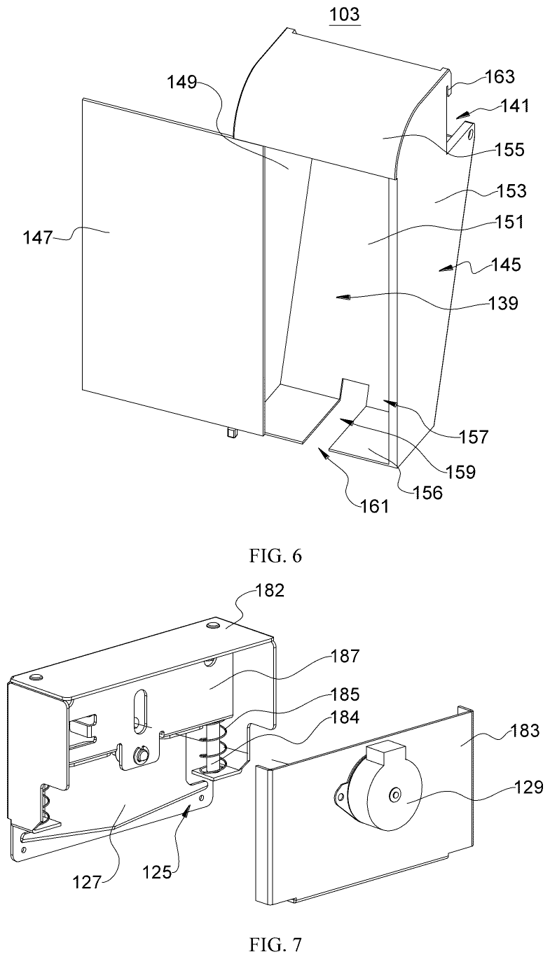

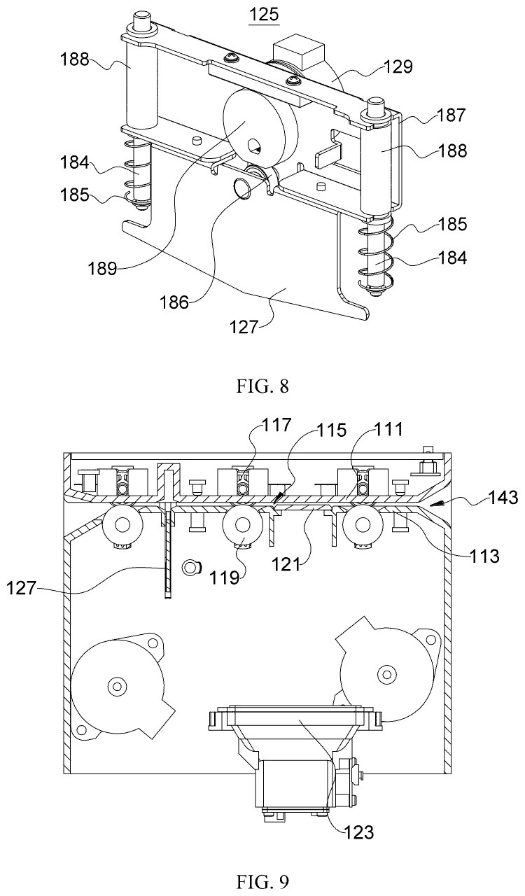

FIG. 4 is a cross-sectional schematic diagram of a lottery-ticket issuing device 100 according to an embodiment of the present application, FIG. 5 is a schematic structural diagram one of a ticket receiving mechanism 103 of a lottery-ticket issuing device 100 according to an embodiment of the present application, FIG. 6 is a schematic structural diagram two of a ticket receiving mechanism 103 of a lottery-ticket issuing device 100 according to an embodiment of the present application, FIG. 7 is a partial exploded schematic diagram of a ticket issuing mechanism 101 of a lottery-ticket issuing device 100 according to an embodiment of the present application, and FIG. 8 is a schematic structural diagram of a cutting assembly 125 of a lottery-ticket issuing device 100 according to an embodiment of the present application. Referring to FIGS. 3 to 8, in this embodiment, the lottery-ticket issuing device 100 includes a ticket issuing mechanism 101 and a ticket receiving mechanism 103. The ticket issuing mechanism 101 is configured to receive the lottery-ticket 109 output by the ticket exit mechanism 226, and the ticket receiving mechanism 103 is configured to receive a single lottery-ticket 109 and enable the received lottery-tickets 109 to be stacked in the ticket receiving mechanism 103, so that the user may take away the lottery-tickets 109 stacked within the ticket receiving mechanism 103 through the ticket pickup port 208.

The ticket issuing mechanism 101 includes a first base frame 105, and the first base frame 105 is in transmission connection with the vertical beam 211 through the first driving mechanism. The ticket issuing mechanism 101 further includes a conveyance assembly 116, a cutting assembly 125, and an identification assembly which are disposed on the first base frame 105. The conveyance assembly 116, the cutting assembly 125 and the identification assembly are all electrically or communicatively connected to the controller. The first base frame 105 includes a first channel plate 111 and a second channel plate 113 which are opposite to each other and disposed at intervals, and a ticket issuing channel 115 is formed between the first channel plate 111 and the second channel plate 113. The conveyance assembly 116 includes a first conveyance roller 117 and a second conveyance roller 119 which are disposed opposite to each other in the ticket issuing channel 115, and the first conveyance roller 117 and the second conveyance roller 119 are configured to clamp the lottery-ticket 109 and drive the lottery-ticket 109 to advance or retreat in the ticket issuing channel 115. The identification member is configured to collect information about the lottery-ticket 109 within the ticket issuing channel 115. The cutting assembly 125 is configured to cut off a first lottery-ticket 109 of multiple consecutive lottery-tickets from a roll of or a stack of lottery-tickets. During the ticket issuing operation, the identification assembly may collect information about the lottery-ticket 109 within the ticket issuing channel 115 and send the information to the controller, the controller activates the lottery-ticket 109, and after the activation of the lottery-ticket 109 is completed, the controller may control the cutting assembly 125 to cut off the first lottery-ticket 109, and control the conveyance assembly 116 to issue the cut-off single lottery-ticket 109 to the ticket receiving mechanism 103, so that the cut-off lottery-ticket 109 may be stacked within the ticket receiving mechanism 103.

It is to be noted that, referring again to FIG. 4, in this embodiment, the identification assembly includes a housing and an identification member 122 disposed within the housing, the housing is embedded in the first channel plate 111 and fixedly connected to the first channel plate 111 by means of a fastener, and the identification member 122 is configured to collect information about the lottery-ticket 109. FIG. 9 is a cross-sectional schematic diagram of a ticket issuing mechanism 101 of a lottery-ticket issuing device 100 according to another embodiment of the present application. Referring to FIG. 9, in another lottery-ticket issuing device 100, the first base frame 105 includes a first channel plate 111, a second channel plate 113 and a transparent plate 121. The first channel plate 111 is disposed to be opposite to and spaced apart from the second channel plate 113, the transparent plate 121 is embedded in the second channel plate 113 and is disposed to be opposite to and spaced apart from the first channel plate 111, and the transparent plate 121 and the second channel plate 113 together form the ticket issuing channel 115 with the first channel plate 111. The identification assembly is disposed on a side of the transparent plate 121 facing away from the ticket issuing channel 115 and is disposed to be opposite to and spaced apart from the transparent plate 121. The housing of the identification assembly is fixedly connected to the first base frame 105 through the fastener. The identification member 122 of the identification assembly may collect information about the lottery-ticket 109 within the ticket issuing channel 115 through the transparent plate 121.

Referring again to FIGS. 7 and 8, in order to facilitate the installation of the cutting assembly 125, in this embodiment, the first base frame 105 includes a first fixing plate 182 and a second fixing plate 183 which are fixedly connected, the first fixing plate 182 and the second fixing plate 183 are connected to form a fixing cavity having an opening, and the cutting assembly 125 is disposed within the fixing cavity and includes at least two guide shafts 184, a supporting plate 187, a blade 127, at least two compression springs 185 and a drive assembly. All guide shafts 184 are parallel and disposed at intervals and are fixedly connected to the first fixing plate 182, exemplarily, two guide shafts 184 are provided and disposed adjacent to two ends of the first fixing plate 182 in the left-and-right direction, respectively. The blade 127 is fixedly connected to the supporting plate 187, two guide sleeves 188 are fixedly disposed at two ends of the supporting plate 187, and the two guide sleeves 188 are respectively sleeved with the two guide shafts 184 and may move along a corresponding guide shaft 184. The drive assembly is in transmission connection with either the supporting plate 187 or the blade 127, for example, the drive assembly is in transmission connection with the supporting plate 187 to indirectly drive the blade 127 to move relative to the first base frame 105 through the supporting plate 187. Moreover, the blade 127 has a paper cutting position capable of extending out of the fixed cavity from the opening when the blade 127 moves relative to the first base frame 105 and an avoidance position located within the fixed cavity. When the blade 127 is located at the paper cutting position, the blade 127 extends into the ticket issuing channel 115 for cutting off the lottery-ticket 109. When the blade 127 is located at the avoidance position, the blade 127 exits the ticket issuing channel 115. The number of the compression springs 185 is correspondingly set to two, the two compression springs 185 are respectively sleeved on the two guide shafts 184, and each compression spring 185 is abutted between the first fixing plate 182 and the supporting plate 187, so that the blade 127 always has a tendency to move towards the avoidance position.

The guide shaft 184 and the guide sleeve 188 are cooperated so that the stability of the movement of the blade 127 between the paper cutting position and the avoidance position can be improved, the reliability and stability of the paper cutting operation can be ensured, and each lottery-ticket 109 cut off by the blade 127 is ensured to be a complete ticket face. The compression spring 185 is provided so that the accidental extension of the blade 127 can be reduced, thereby ensuring the normal operation of the lottery-ticket issuing device 100. Of course, in other embodiments, the number of guide shafts 184, guide sleeves 188, and compression springs 185 may also be adjusted according to requirements.

Referring again to FIG. 9, in this embodiment, the drive assembly includes a cutting motor 129, a cam 189 and a transmission wheel 186. The cutting motor 129 is disposed on the second fixing plate 183, the transmission wheel 186 is connected to the supporting plate 187, the cam 189 is connected to an output shaft of the cutting motor 129, and an outer circumferential surface of the cam 189 is abutted against the transmission wheel 186. When the cam 189 rotates, the supporting plate 187 is driven by the transmission wheel 186 against the elastic force of the compression spring 185, and thus the blade 127 is driven to move towards the paper cutting position. The cutting assembly 125 is provided so that the reliability of cutting the ticket and the efficiency of issuing the lottery-ticket 109 can be improved. Of course, in other embodiments, the cutting assembly 125 may be selected as other linear drive structure, such as a cylinder.

Referring again to FIGS. 3 to 6, in this embodiment, the ticket receiving mechanism 103 may include a second base frame 107 connected to the first base frame 105. The second base frame 107 has a ticket receiving cavity 139 communicating with the ticket issuing channel 115, and a single lottery-ticket 109 output from the ticket issuing channel 115 may enter the ticket receiving cavity 139 and be stacked within the ticket receiving cavity 139. The ticket receiving cavity 139 has a guide surface 131 and a supporting surface 133. The guide surface 131 is configured to guide the lottery-ticket 109 output by the ticket issuing channel 115 to change a movement direction, so that the lottery-ticket 109 may be stacked on the supporting surface 133 in the direction at the angle from the vertical direction. In this lottery-ticket issuing device 100, the guide surface 131 and the supporting surface 133 are provided so that a front end of the lottery-ticket 109 may abut against the guide surface 131 when disengaged from the ticket issuing channel 115, to change the movement direction of the lottery-ticket 109. The guide surface 131 guides the lottery-ticket 109 to move towards the supporting surface 133, so that the lottery-ticket 109 may be stacked on the supporting surface 133 in the direction at the angle from the vertical direction, thereby reducing the size of the space occupied by the ticket receiving cavity 139 in the horizontal direction, moreover, improving the regularity of the stacking of the multiple lottery-tickets 109 within the ticket receiving cavity 139, and further ensuring the efficient execution of the issuing operation of the lottery-ticket.

As an optional solution, in this embodiment, the supporting surface 133 includes a first surface 135 and a second surface 137 disposed at an obtuse angle from the first surface 135 (i. e., a in FIG. 4, exemplarily, a may be selected as) 120°. The first surface 135 and the second surface 137 are both planes at an angle from a vertical plane, the first surface 135 is configured to support the front end of the lottery-ticket 109, and the second surface 137 is configured to support a surface of the lottery-ticket 109. The first surface 135 and the second surface 137 of the supporting surface 133 are disposed at an obtuse angle, and the second surface 137 extends in a direction close to the ticket issuing channel 115. Therefore, after a first lottery-ticket 109 outputted by the ticket issuing channel 115 enters the ticket receiving cavity 139, a front end of the first lottery-ticket 109 is in contact with the first surface 135, a rear end of the lottery-ticket 109 is quickly or even simultaneously in contact with the second surface 137, whereby one surface of the first lottery-ticket 109 is supported by the second surface 137. As the ticket issuing mechanism 101 continues to convey the lottery-ticket to the ticket receiving mechanism 103, after a second lottery-ticket 109 output from the ticket issuing channel 115 enters the ticket receiving cavity 139, when a front end of the second lottery-ticket is in contact with the first surface 135, a rear end of the second lottery-ticket 109 is quickly or even simultaneously in contact with the first lottery-ticket; therefore, a surface of the second lottery-ticket is bonded to another surface of the first lottery-ticket, and so on, so that front ends of multiple lottery-tickets 109 entering the ticket receiving cavity 139 are sequentially arranged on the first surface 135, surfaces of the multiple lottery-tickets 109 are sequentially bonded, whereby the multiple lottery-tickets 109 are stacked in the direction at the angle from the vertical direction, thereby reducing the size of the space occupied by the ticket receiving cavity 139 in the horizontal direction.

In this embodiment, the guide surface 131 is a vertical plane, the first surface 135 is a horizontal surface perpendicular to the guide surface 131, the second surface 137 and the guide surface 131 are opposite to each other and arranged at intervals, and the second surface 137 and the guide surface 131 are disposed at an acute angle, to reduce the size of the ticket receiving cavity 139 in the horizontal direction. Exemplarily, the second surface 137 is an inclined surface. The guide surface 131 is configured to guide a single lottery-ticket 109 output from the ticket issuing channel 115 to move vertically downward and enable the lottery-ticket 109 to be stacked on the first surface 135 and the second surface 137 in the horizontal direction. With this arrangement, the front end of the lottery-ticket 109 entering the ticket receiving cavity 139 collides with the guide surface 131 first under the action of inertia, and moves vertically downwards by changing the movement direction along the guide surface 131. When the front end of the lottery-ticket 109 is in contact with the first surface 135, the rear end of the lottery-ticket 109 is in contact with the second surface 137, the surface of the lottery-ticket 109 is supported by the second surface 137. As the number of the lottery-tickets 109 within the ticket receiving cavity 139 increases, the front end of each lottery-ticket 109 is in contact with the first surface 135, front ends of multiple lottery-tickets 109 are sequentially arranged in the horizontal direction, and a surface of a next lottery-ticket 109 is attached to a surface of the previous lottery-ticket 109, so that the multiple lottery-tickets 109 may be stacked within the ticket receiving cavity 139 in the horizontal direction, a length of each lottery-ticket 109 within the ticket receiving cavity 139 may extend substantially in a direction parallel to the second surface 137, and a thickness of each lottery-ticket 109 extends in a direction perpendicular to the second surface 137. Since the first surface 135 is the horizontal surface, the second surface 137 and the first surface 135 are disposed at an obtuse angle, so that the space occupied by the ticket receiving cavity 139 in the horizontal direction is reduced, moreover, the regularity of the stacking of the multiple lottery-tickets 109 within the ticket receiving cavity 139 is improved, and it is convenient for the user to take away the lottery-ticket once. Of course, in other embodiments, the first surface 135 may also be an inclined surface at an angle from both the horizontal surface and the vertical surface, so that the lottery-ticket 109 may be stacked on the first surface 135 and the second surface 137 in the direction at the angle from the vertical direction.

Optionally, in this embodiment, the ticket issuing channel 115 has a ticket entry port 227 and a ticket exit port 143 in a direction in which the lottery-ticket 109 advances within the ticket issuing channel 115. The ticket entry port 227 is configured to make the lottery-ticket 109 enter the ticket issuing channel 115, and the ticket exit port 143 is configured to output the lottery-ticket 109 within the ticket issuing channel 115. The guide surface 131 and the ticket exit port 143 are opposite to each other and disposed at intervals, and the guide surface 131 is located downstream of the ticket exit port 143 in a direction in which the lottery-ticket 109 within the ticket issuing channel 115 is output through the ticket exit port 143. A minimum spacing between the guide surface 131 and the ticket exit port 143 is less than a length of the single lottery-ticket 109 within the ticket issuing channel 115 in a direction where the single lottery-ticket 109 moves along the ticket issuing channel 115. Moreover, a size of the first surface 135 in the horizontal direction is less than the length of the single lottery-ticket 109 within the ticket issuing channel 115 in the direction where the single lottery-ticket 109 moves along the ticket issuing channel 115.

On one hand, the minimum spacing between the guide surface 131 and the ticket exit port 143 is less than the length of the single lottery-ticket 109 within the ticket issuing channel 115 in the direction where the single lottery-ticket 109 moves along the ticket issuing channel 115, so that the front end of the lottery-ticket 109 already reliably is abutted against the guide surface 131 before the lottery-ticket 109 is completely separated from the ticket issuing channel 115 (i.e. the rear end of the lottery-ticket 109 is separated from the ticket exit port 143). Under the inertia effect of the movement of the lottery-ticket 109 and the guidance of the guide surface 131, the lottery-ticket 109 is more easily bent downwards to change the movement direction, and thus the lottery-ticket 109 is more easily moved vertically downwards until the front end of the lottery-ticket 109 is abutted against the first surface 135. On the other hand, the size of the first surface 135 in the horizontal direction is less than the length of the single lottery-ticket 109 within the ticket issuing channel 115 in the direction where the single lottery-ticket 109 moves along the ticket issuing channel 115; therefore, when the rear end of the lottery-ticket 109 is separated from the ticket exit port 143, the rear end of the lottery-ticket 109 falls under its own weight, the rear end of the lottery-ticket 109 is abutted against the second surface 137 quickly or even simultaneously, the surface of the lottery-ticket 109 is supported by the second surface 137, and the front end and the rear end of the lottery-ticket 109 is abutted against respective supporting surfaces substantially simultaneously, so that the lottery-ticket 109 may be stacked on the first surface 135 and the second surface 137 in the horizontal direction after the lottery-ticket 109 is completely separated from the ticket issuing channel 115, thereby improving the regularity of the stacking of the lottery-tickets 109. In addition, in this embodiment, the change of the conveyance direction of the lottery-tickets 109 and the stacking of the lottery-tickets 109 in the horizontal direction can be achieved through the arrangement of three planes, the structure is simple and reliable, and the cost is relatively low.

Optionally, referring to FIGS. 4 to 6 again, in this embodiment, the guide surface 131, the first surface 135 and the second surface 137 are disposed to be connected in sequence. The first surface 135 is located below the ticket exit port 143 in the vertical direction. An extension direction of at least part of the ticket issuing channels 115 close to the ticket exit port 143 forms an angle with both the horizontal direction and the vertical direction, that is, the at least part of the ticket issuing channels 115 are inclined with respect to both the horizontal direction and the vertical direction, so that when the ticket issuing channel 115 outputs the lottery-ticket 109 through the ticket exit port 143, the lottery-ticket 109 is conveyed obliquely downwards towards the guide surface 131, whereby the front end of the lottery-ticket 109 may be changed to be moved downwards more easily when the front end of the lottery-ticket 109 is abut against the guide surface 131, thereby avoiding the breaking of the lottery-ticket 109 due to excessive bending. Exemplarily, the ticket issuing channel 115 includes a first channel segment 195 and a second channel segment 196 which are sequentially arranged along the advancing direction of the lottery-ticket 109. The first channel segment 195 is horizontally disposed, and the second channel segment 196 obliquely extends downwards. The ticket entry port 227 is disposed at the starting end of the first channel segment 195, and the ticket exit port 143 is disposed at a tail end of the second channel segment 196.

The guide surface 131 and the ticket exit port 143 are opposite to each other and disposed at intervals, so that the ticket exit port 143 faces the guide surface 131, and the front end of the lottery-ticket 109 output from the ticket exit port 143 may be abutted against the guide surface 131 more quickly, to change the movement direction of the lottery-ticket 109 and enable the front end of the lottery-ticket 109 to be in contact with the first surface 135 as quickly as possible. Moreover, the first surface 135 is located below the ticket exit port 143, and the lottery-ticket 109 output from the second channel segment 196 via the ticket exit port 143 moves obliquely downward, so that the lottery-tickets 109 are more easily bent under the guidance of the guide surface 131 and fall down and are stacked on the first surface 135 and the second surface 137 after the lottery-tickets 109 are output from the ticket issuing channel 115, thereby improving the uniformity of the stacking of the lottery-ticket 109 within the ticket receiving cavity 139. In addition, the guide surface 131, the first surface 135 and the second surface 137 are disposed to be connected in sequence, and the second surface 137 and the guide surface 131 are disposed at an acute angle, so that the spacing between the guide surface 131 and the second surface 137 is smaller, the size of the whole ticket receiving cavity 139 in the horizontal direction is smaller, the structure is more compact, the lottery-ticket 109 can be ensured to be stacked on the first surface 135 and the second surface 137 in the horizontal direction, and the regularity of the stacking of the lottery-tickets 109 is ensured. Referring to FIGS. 3 to 6 again, in this embodiment, the second base frame 107 includes a box body 145 and a door body 147. The box body 145 has an output port 157, the door body 147 is movably connected to the box body 145, and is configured to open or close the output port 157. When the door body 147 closes the output port 157, the door body 147 and the box body 145 jointly form the ticket receiving cavity 139, an inner side surface of the door body 147 and/or an inner side surface of the box body 145 forms the guide surface 131, and a bottom surface of the box body 145 and the inner side surface of the box body 145 jointly form the supporting surface 133.

Exemplarily, the box body 145 includes a first plate 149, a second plate 151, a third plate 153, a fourth plate 155 and a fifth plate 156. The first plate 149 and the third plate 153 are vertical flat plates and are disposed to be parallel to each other, and the second plate 151 is an inclined flat plate connected between the first plate 149 and the third plate 153. The fourth plate 155 is connected to a top end of the first plate 149, a top end of the second plate 151 and a top end of the third plate 153, the fourth plate 155 is arc-shaped, the fourth plate 155 and the top end of the first plate 149, the top end of the second plate 151 and the top end of the third plate 153 jointly form an input port 141, and the input port 141 is communicating with the ticket exit port 143 of the ticket issuing channel 115. The fifth plate 156 is connected to a bottom end of the first plate 149, a bottom end of the second plate 151, and a bottom end of the third plate 153, and the fifth plate 156, the first plate 149, the third plate 153 and the fourth plate 155 jointly form the output port 157. The door body 147 is a vertical flat plate, the door body 147 is movably disposed at the output port 157 of the box body 145, the door body 147 and the second plate 151 are opposite to each other and disposed at intervals, and the door body 147 is configured to open or close the output port 157. When the door body 147 closes the output port 157, the door body 147 and the box body 145 jointly form the ticket receiving cavity 139. At this time, the inner side surface of the door body 147 forms the guide surface 131, an upper surface of the fifth plate 156 (i. e., the bottom surface of the box body 145) forms the first surface 135, and an inner side surface of the second plate 151 forms the second surface 137.

With such an arrangement, the guide surface 131, the first surface 135 and the second surface 137 may be formed by fully utilizing the structure of the second base frame 107 itself, so that the structure of the entire second base frame 107 is more compact and the occupied space is smaller. Of course, in other embodiments, the box body 145 may further include a sixth plate configured as a vertical flat plate, the sixth plate is connected to the first plate 149, the third plate 153, the fourth plate 155 and the fifth plate 156 simultaneously, the output port 157 is disposed on the sixth plate, and an inner surface of the sixth plate and an inner surface of the door body 147 jointly form the guide surface 131. Alternatively, the output port 157 is disposed on the second plate 151, an inner side surface of the sixth plate forms the guide surface 131, an upper surface of the fifth plate 156 forms the first surface 135, and the inner side surface of the door body 147 and the inner side surface of the second plate 151 jointly form the second surface 137.

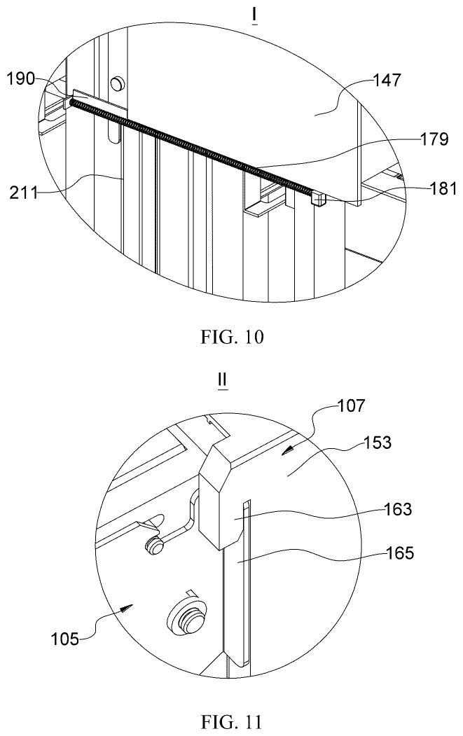

Exemplarily, FIG. 10 is an enlarged partial view of area I of FIG. 1. Referring to FIGS. 1 and 10, since the lottery-ticket issuing device 100 is located within the cabinet 201, in order to facilitate the user in driving the door body 147 through the ticket pickup port 208 to open the output port 157, to facilitate taking out the lottery-ticket 109, in this embodiment, the door body 147 may be slidably connected to the box body 145.

A sliding groove extending in the left-and-right direction may be disposed on one of the box body 145 and the door body 147, a guide portion extending in the left-and-right direction may be disposed on the other of the box body 145 and the door body 147, and the guide portion is slidably fitted with the guide groove. Moreover, a connection member 190 is fixedly disposed on the box body 145 and is located at a position adjacent to the bottom of the box body 145, and the connection member 190 is located at a position of the box body 145 close to the vertical beam 211. A supporting protrusion 181 is disposed at a position on a bottom end of the door body 147 facing away from the vertical beam 211, the supporting protrusion 181 and the connection member 190 are disposed at intervals in the left-and-right direction, a spring 179 is disposed to be connected between the supporting protrusion 181 and the connection member 190, and the spring 179 is configured so that the door body 147 always has the tendency of movement to close the output port 157. When the user takes the ticket, the user can push the door body 147 to compress the spring 179 to open the output port 157. Moreover, in order to facilitate the user in pushing the door body 147 when the user takes the lottery-ticket 109, an end portion of the door body 147 may also be disposed to protrude a certain length from the box body 145. The door body 147 is slidably fitted with the box body 145, so that a process of opening or closing the output port 157 by the door body 147 does not take up much space within the cabinet body 202, and the structure of the lottery-ticket vending machine 200 may be more compact. Of course, in other embodiments, in a case where the space and the cost are allowed, the door body 147 may also be pivotally connected to the box body 145, and the door body 147 is configured to open or close the output port 157 when the door body 147 rotates.

In other embodiments, the first surface 135 may be disposed to be a plane above the ticket exit port 143, and the second side 137 may be disposed to be an inclined plane above the ticket exit port 143. Moreover, the ticket receiving mechanism 103 further includes a pushing member configured to push the lottery-ticket 109 guided by the guide surface 131 towards the first surface 135 and the second surface 137. Moreover, the guide plate may also be disposed inside the second base frame 107, so that any one vertical surface of the guide plate may form the guide surface 131.

Referring to FIG. 6 again, in this embodiment, the box body 145 is also provided with an elongated hole 159 in a penetrating manner. Exemplarily, the elongated hole 159 extends from the inner side surface of the box body 145 to the output port 157 via the bottom surface of the box body 145, that is, the elongated hole 159 extends from the second plate 151 to the output port 157 via the fifth plate 156. In order to make the structure of the second base frame 107 more compact, a size of the second plate 151 in the left-and-right direction is generally adapted to a size of the single lottery-ticket 109 in the left-and-right direction. Since no extra operation space exists, it is not convenient for the user to take out the lottery-ticket 109 within the ticket receiving cavity 139 directly through the output port 157. In this case, the elongated hole 159 is provided so that the front ends of the multiple lottery-tickets 109 stacked within the ticket receiving cavity 139 may be partially exposed through the elongated hole 159, the user can extend from the bottom of the box body 145 into the ticket receiving cavity 139 through the elongated hole 159 to contact the front ends of the lottery-tickets 109, whereby it is easier to take out the lottery-tickets 109 on the supporting surface 133, thereby improving the convenience and the reliability of the take out operation of the lottery-ticket 109. In addition, with such an arrangement, the stacking situation of the multiple lottery-tickets 109 may also be observed via the elongated hole 159, so that the lottery-tickets 109 may be adjusted in time when the lottery-tickets 109 are not stacked neatly, and the lottery-tickets 109 may also be taken out in time when the ticket receiving cavity 139 is filled with the lottery-tickets 109.

It is to be noted that, referring to FIG. 6 again, in this embodiment, the elongated hole 159 is a rectangular hole, a part of the elongated hole 159 is disposed at the bottom end of the second plate 151, another part of the elongated hole 159 penetrates through the fifth plate 156 in the front-rear direction, and a notch 161 communicating with the output port 157 is formed at an end of the fifth plate 156 facing away from the second plate 151. On the one hand, a part of the elongated hole 159 is disposed on the second plate 151, so that when the number of lottery-tickets 109 stacked within the ticket receiving cavity 139 is relatively few, such as, only one lottery-ticket 109, the lottery-ticket 109 may be pulled in a direction close to the output port 157 via the elongated hole 159 disposed on the second plate 151, to facilitate picking up the lottery-ticket 109. On the other hand, the notch 161 is provided so that the user may conveniently contact the lottery-ticket 109 through the notch 161, thereby facilitating the operation of the user and ensuring that the user can take out the lottery-ticket 109 in time. Of course, in other embodiments, a shape of the elongated hole 159 may be adjusted according to requirements, and the elongated hole 159 may also be disposed on the first plate 149 or the third plate 153, or even the fourth plate 155, so that the user may conveniently pick up the lottery-ticket 109.

FIG. 11 is an enlarged partial view of area II of FIG. 3. Referring to FIGS. 3 to 11, in order to ensure the compactness and stability of the structure of the entire lottery-ticket issuing device 100, in this embodiment, the first base frame 105 and the second base frame 107 are fitted to be fixedly connected after being hitched. Of course, in other embodiments, either of the fixed connection fit or the hitch fit may be selected, or even an inserting fit or a magnetic attraction fit and the like may be selected, as long as the stability, the reliability and the safety of the first base frame 105 and the second base frame 107 can be ensured after the first base frame 105 and the second base frame 107 are fitted.

In order to achieve the hitch fit, in this embodiment, one of the first base frame 105 and the second base frame 107 is provided with a hanging hook 163, and the other of the first base frame 105 and the second base frame 107 is provided with a hanging plate 165. Exemplarily, each of ends of two sides of the first base frame 105 close to the ticket exit port 143 is bent to form one hanging plate 165. Each of ends of the first plate 149 and the third plate 153 of the second base frame 107 close to the fourth plate 155 is bent to form one hanging hook 163. The two hanging hooks 163 are hitched to the two hanging plates 165 in one-to-one correspondence. With such an arrangement, the stability of the first base frame 105 and the second base frame 107 after being fitted can be ensured, moreover, the installation and detachment of the first base frame 105 and the second base frame 107 are facilitated, and the positioning is also facilitated achieving, so that after the hanging hook 163 and the hanging plate 165 are hitched, and the ticket exit port 143 of the ticket issuing channel 115 may be exactly opposite to and communicated with the input port 141 of the second base frame 107.

It is to be noted that, in this embodiment, the hanging hook 163 is hitched to the hanging plate 165 in the vertical direction. The hanging hook 163 and the hanging plate 165 are disposed to be hitched in the vertical direction, so that the fit of the first base frame 105 and the second base frame 107 in the vertical direction can be ensured, and the stability and the reliability of the fitting can be ensured by virtue of the gravity action of the second base frame 107. Of course, in other embodiments, a fitting direction of the hanging hook 163 and the hanging plate 165 may also be other directions at the angle from the vertical direction.

By the same reasoning, in order to achieve the fixed connection, in this embodiment, the ticket exit port 143 of the first base frame 105 passes through the input port 141 of the second base frame 107 and is located within the ticket receiving cavity 139. One fastening hole is formed on each of two sides of the first base frame 105, and fastening holes are correspondingly formed on the first plate 149 and the third plate 153 of the second base frame 107. Two fasteners may be securely connected to the first base frame 105 and the second base frame 107 through corresponding two fastening holes, respectively, so that the stability of the first base frame 105 and the second base frame 107 after the first base frame 105 and the second base frame 107 are hitched and fitted can be improved, thereby ensuring the stability and reliability of operations of transporting, issuing, and picking up the lottery-ticket 109. Of course, in other embodiments, the ticket exit port 143 and the input port 141 may be disposed at intervals, in this case, the ticket exit port 143 may be disposed to be opposite to and spaced apart from the guide surface 131 through the input port 141, to ensure that the lottery-ticket 109 output from the ticket issuing channel 115 may move towards the first surface 135 and the second surface 137 under the guidance of the guide surface 131.

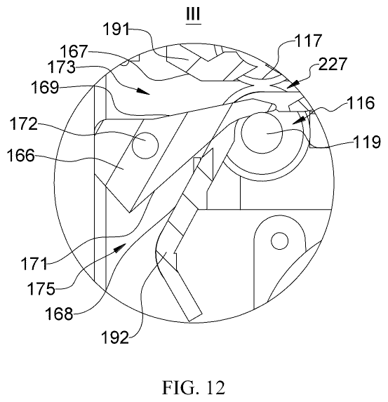

FIG. 12 is an enlarged partial view of area III of FIG. 4. Referring to FIGS. 4 and 12, in this embodiment, the first base frame 105 further includes a first guide surface 167 and a second guide surface 168, and the ticket issuing channel 115 further has a ticket entry port 227. Exemplarily, the first base frame 105 further includes a first guide plate 191 and a second guide plate 192. One end of the first guide plate 191 is connected to one end forming the ticket entry port 227 of the first channel plate 111, and one end of the second guide plate 192 is connected to one end forming the ticket entry port 227 of the second channel plate 113. The first guide plate 191 and the second guide plate 192 are disposed in a trumpet shape. The first guide surface 167 is formed by a surface of the first guide plate 191, and the second guide surface 168 is formed by a surface of the second guide plate 192, so that the first guide surface 167 and the second guide surface 168 are arranged substantially in an inverted Chinese character “ [symbol] ”-shaped. Moreover, the ticket issuing mechanism 101 further includes a reversing member 166 rotationally disposed on the first base frame 105, the reversing member 166 is located between the first guide surface 167 and the second guide surface 168, i. e., located within the Chinese character “ [symbol] ”-shaped space. The reversing member 166 has a third guide surface 169 and a fourth guide surface 171 which face away from each other, the third guide surface 169 is disposed close to the first guide surface 167, and the fourth guide surface 171 is disposed close to the second guide surface 168. Moreover, the reversing member 166 is locatable between a first position and a second position when the reversing member 166 rotates relative to the first base frame 105. When the reversing member 166 is located in the first position, the third guide surface 169 and the first guide surface 167 are opposite to each other and disposed at intervals to form a ticket entry channel 173 communicating with the ticket entry port 227 of the ticket issuing channel 115 (i. e., the ticket entry channel 173 is formed by the reversing member 166 and the first guide plate 191), and the ticket entry channel 173 is configured to input the lottery-ticket 109 into the ticket issuing channel 115. When the reversing member 166 is in the second position, the fourth guide surface 171 and the second guide surface 168 are opposite to each other and are disposed at intervals, a recycling channel 175 communicating with the ticket entry port 227 of the ticket issuing channel 115 is formed (i. e., the recycling channel 175 is formed by the reversing member 166 and the second guide plate 192), and the recycling channel 175 is configured to receive the lottery-ticket 109 returned from the ticket issuing channel 115.

With such an arrangement, when the identification member 122 feeds back an identification result to the controller, the controller determines, according to the identification result, that the surface of the lottery-ticket 109 is dirty and incomplete, or that the lottery-ticket 109 is not the lottery-ticket 109 used by the lottery-ticket vending machine 200, the controller may determine the lottery-ticket 109 as an invalid lottery-ticket 109. Since the invalid lottery-ticket 109 does not need to be activated, in this case, the lottery-ticket 109 may be cut off by the cutting assembly 125 and may be recycled through the recycling channel 175. Of course, in other embodiments, the lottery-ticket 109 determined to be needlessly activated may also be recovered in a manner of controlling the conveyance roller to rotate in reverse to roll back the lottery-ticket 109.

It is to be noted that the reversing member 166 may be pivotally connected to the first base frame 105 via a pivot shaft 172, an elastic member may be connected between the pivot shaft 172 and the first base frame 105, and the elastic force of the elastic member makes the reversing member 166 have a tendency to rotate towards the first position, so that the reversing member 166 is always in the first position without the external force, and the lottery-ticket 109 within the ticket entry channel 173 may be transported to the ticket issuing channel 115. By the same reasoning, the reversing member 166 may also be provided with one drive structure such as a drive motor or an electromagnet in a transmission connection manner, and the drive motor or the electromagnet is electrically connected or in communication connection with the controller, so that when the controller feeds back that the lottery-ticket 109 needs to be recycled, the reversing member 166 is driven to move towards the second position against the action force of the elastic member, to achieve the reversing and thus the recycling of the lottery-ticket 109.

As an optional solution, in order to facilitate the recycling of the lottery-ticket 109, in this embodiment, as shown in FIG. 1, a recycling box 215 is also disposed within the lottery-ticket vending machine 200, and the recycling box 215 has a recycling port 217 facing upwards. The lottery-ticket issuing device 100 has a ticket receiving position interfacing with the ticket exit device 218 and a ticket pickup position interfacing with the ticket pickup port 208, and further has a recycling position interfacing with the recycling box 215. When a recycling operation of the lottery-ticket 109 needs to be performed, the first driving mechanism and the second driving mechanism may drive the lottery-ticket issuing device 100 to move towards the recycling position, until an outlet of the recycling channel 175 is opposite to and communicates with the recycling port 217 to enable the lottery-ticket 109 within the recycling channel 175 enter the recycling box 215 via the recycling port 217.

With such an arrangement, when the controller determines that the lottery-ticket 109 is an invalid lottery-ticket 109, the movement of the reversing member 166 to the second position can be controlled, so that the recycling channel 175 is formed between the reversing member 166 and the second channel plate 113. Moreover, the first driving mechanism and the second driving mechanism are controlled to drive the lottery-ticket issuing device 100 to move towards the recycling position, so that the outlet of the recycling channel 175 may communicate with the recycling port 217 to output the lottery-ticket 109 to the recycling port 217, and the recycling box 215 may receive the lottery-ticket 109 output from the recycling channel 175. That is, such an arrangement enables the invalid lottery-ticket 109 to be stored centrally, thereby facilitating the centralized processing of the invalid lottery-ticket 109. Therefore, the lottery-ticket vending machine 200 has the recycling function.

It is to be noted that, in this embodiment, the recycling box 215 is disposed at the bottom of the cabinet body 202 and is located below the multiple ticket exit devices 218 disposed in N rows and M columns. With such an arrangement, the recycling box 215 does not interfere with the lottery-ticket issuing device 100 to take the ticket among the multiple ticket issuing devices 218, thereby improving the smoothness of the movement of the lottery-ticket issuing device 100. Of course, in other embodiments, the recycling box 215 may also be disposed on a left side or a right side of all ticket exit devices 218 without interfering with the ticket receiving operation and the ticket pickup operation.

It is also to be noted that, in other embodiments, the ticket entry channel 173 and the recycling channel 175 may also be directly formed inside the first base frame 105. In this case, the reversing member 166 may be disposed inside the first base frame 105 and located among the ticket entry channel 173, the ticket issuing channel 115 and the recycling channel 175. Likewise, the reversing member 166 is locatable between a first position and a second position when the reversing member 166 rotates relative to the first base frame 105. When the reversing member 166 is in the first position, the ticket issuing channel 115 communicates with the ticket entry channel 173, and the ticket issuing channel 115 does not communicate with the recycling channel 175, so that the lottery-ticket 109 may enter the ticket issuing channel 115 from the ticket entry channel 173. When the reversing member 166 is in the second position, the ticket issuing channel 115 does not communicate with the ticket entry channel 173, the ticket issuing channel 115 communicates with the recycling channel 175, and the lottery-ticket 109 within the ticket issuing channel 115 may retreat to the recycling channel 175.

Referring again to FIGS. 1 and 2, in order to ensure the efficient execution of the ticket pickup operation, in this embodiment, the lottery-ticket vending machine 200 further includes at least one of a banknote receiving device 204, a barcode scanning device 205, a printing device 206 and a certificate card identification device 209. Exemplarily, the lottery-ticket vending machine 200 further includes a banknote receiving device 204. The banknote receiving device 204 is disposed on the cabinet door 203 and is exposed from an opening on the cabinet door 203. The banknote receiving device 204 is electrically connected or communicatively connected to the controller and is configured to receive the banknote of the user when the user purchases the lottery-ticket 109. Exemplarily, the lottery-ticket vending machine 200 further includes the barcode scanning device 205. The barcode scanning device 205 is also disposed on the cabinet door 203 and is used for the user to perform scanning to complete payment, or is used for the user to perform scanning to acquire information about the lottery-ticket 109. Exemplarily, the lottery-ticket vending machine 200 further includes a printing device 206. The printing device 206 is disposed within the cabinet body 202, an outlet of the printing device 206 is exposed from the cabinet door 203, and the printing device 206 is electrically connected or communicatively connected to the controller and is used for printing a receipt list after the output of the lottery-ticket 109 is completed to be reserved for the user. Exemplarily, the lottery-ticket vending machine 200 further includes a certificate card identification device 209. The certificate card identification device 209 is disposed within the cabinet body 202 and is exposed from an opening of the cabinet door 203, and the certificate card identification device 209 may perform identification of an identity card or a bank card to assist in performing the ticket pickup operation.

Of course, in other embodiments, the lottery-ticket vending machine 200 may also be provided with a keyboard for the user to input the password, may also be provided with a fingerprint identification device for the fingerprint identification when the worker maintains the device, and may even also be provided with a display screen or a touch operation screen according to requirements for the user or the worker to use.

The operation process and the beneficial effects of the lottery-ticket vending machine 200 provided in the embodiments of the present application will be introduced below. When the user purchases a lottery-ticket 109, the user inputs an amount corresponding to the purchase of the lottery-ticket 109 into the banknote receiving device 204, or the user performs a code scanning payment through the barcode scanning device 205. After the controller receives the payment information from the user, the lottery-ticket issuing device 100 may be controlled to move to a target ticket receiving position through the first driving mechanism and the second driving mechanism, so that the ticket issuing mechanism 101 is docked with the target ticket exit device 218, and then controls the ticket exit device 218 to output the lottery-ticket 109 to the ticket issuing mechanism 101 of the lottery-ticket issuing device 100. The lottery-ticket 109 enters the ticket issuing channel 115 through the ticket entry channel 173, the identification assembly acquires the information of the lottery-ticket 109 and sends an identification result to the controller. After the controller determines that the lottery-ticket 109 is a qualified lottery-ticket 109, the controller controls the cutting assembly 125 to cut off the lottery-ticket 109, and controls the first conveyance roller 117 and the second conveyance roller 119 to move the lottery-ticket 109 within the ticket issuing channel 115 towards the ticket exit port 143. A front end of the lottery-ticket 109 output from the ticket exit port 143 is abutted against the guide surface 131 and moves downward along the guide surface 131. After the lottery-ticket 109 has completely been separately from the ticket exit port 143, the lottery-tickets 109 are stacked on the first surface 135 and the second surface 137 in the horizontal direction, the front end of the lottery-ticket 109 is supported by the first surface 135, and the surface of the lottery-ticket 109 is supported by the second surface 137. After the controller determines that the lottery-ticket 109 is an invalid lottery-ticket, the controller controls the cutting assembly 125 to cut off the lottery-ticket 109, and controls the reversing member 166 to move to the second position, so that the recycling channel 175 communicating with the ticket issuing channel 115 is formed between the reversing member 166 and the second channel plate 113, and the first conveyance roller 117 and the second conveyance roller 119 are controlled to return the lottery-ticket 109 within the lottery channel 115 to the recycling channel 175. Moreover, the controller controls the first driving mechanism and the second driving mechanism to drive the lottery-ticket issuing device 100 to move towards the recycling box 215, so that the outlet of the recycling channel 175 may be opposite to the recycling port 217 of the recycling box 215, and the lottery-ticket 109 within the recycling channel 175 can be output to the recycling box 215 for storage.

In the above-described processes, in the lottery-ticket issuing device 100, the guide surface 131 and the supporting surface 133 are provided so that when the lottery-ticket 109 is separated from the ticket issuing channel 115, the lottery-ticket 109 is guided to be stacked on the supporting surface 133 in the direction at the angle from the vertical direction, thereby being capable of reducing the size of the space occupied by the ticket receiving cavity 139 in the horizontal direction, meanwhile ensuring the regularity of the stacking of the multiple lottery-tickets 109 within the ticket receiving cavity 139, and further ensuring the efficient execution of the issuing operation of the lottery-tickets 109.

The lottery-ticket vending machine 200 provided in this embodiment includes the above-described lottery-ticket issuing device 100. Therefore, the lottery-ticket vending machine 200 has the advantages of being capable of reducing the space occupied by the lottery-ticket issuing device 100 in the horizontal direction, meanwhile ensuring the regularity of the stacking of the lottery-tickets 109 within the ticket receiving cavity 139, and further ensuring the efficient execution of the issuing operation of the lottery-tickets 109.

In conclusion, an embodiment of the present application provides a lottery-ticket issuing device 100 and a lottery-ticket vending machine 200 in which lottery-tickets 109 may be stacked on the ticket receiving mechanism in the direction at the angle from the vertical direction, so that the size of the space occupied by the lottery-ticket issuing device 100 in the horizontal direction can be reduced, and when the size of the lottery-ticket issuing device 100 in the horizontal direction is limited, the regularity of the stacking of the lottery-tickets 109 can be ensured, thereby ensuring the efficient execution of an issuing operation of the lottery-tickets 109.

1. A lottery-ticket issuing device, comprising:
a ticket issuing mechanism comprising a first base frame and a conveyance assembly disposed on the first base frame, wherein the first base frame has a ticket issuing channel, and the conveyance assembly is configured to drive lottery-tickets to move along the ticket issuing channel; and
a ticket receiving mechanism comprising a second base frame connected to the first base frame, wherein the second base frame has a ticket receiving cavity communicating with the ticket issuing channel, the ticket receiving cavity has a guide surface and a supporting surface, and the guide surface is configured to guide the lottery-tickets output from the ticket issuing channel to change a movement direction, so that the lottery-tickets are stacked on the supporting surface in a direction at an angle from a vertical direction.

2. The lottery-ticket issuing device according to claim 1, wherein the supporting surface comprises a first surface and a second surface disposed at an obtuse angle from the first surface, the first surface is configured to support front ends of the lottery-tickets, and the second surface is configured to support surfaces of the lottery-tickets.

3. The lottery-ticket issuing device according to claim 2, wherein the guide surface is a vertical plane, the first surface is arranged to be perpendicular to the guide surface, the second surface and the guide surface are opposite to each other and arranged at intervals, and the guide surface is configured to guide the lottery-tickets output from the ticket issuing channel to move vertically downward and to be stacked on the first surface and the second surface in a horizontal direction.

4. The lottery-ticket issuing device according to claim 3, wherein the ticket issuing channel has a ticket exit port, the guide surface and the ticket exit port are opposite to each other and disposed at intervals, and the guide surface is located downstream of the ticket exit port in a direction in which the lottery-tickets within the ticket issuing channel are output via the ticket exit port; and
a minimum spacing between the guide surface and the ticket exit port is less than a length of the lottery-tickets within the ticket issuing channel in a direction where the lottery-tickets move along the ticket issuing channel, and a size of the first surface in the horizontal direction is less than the length of the lottery-tickets within the ticket issuing channel in the direction where the lottery-tickets move along the ticket issuing channel.

5. The lottery-ticket issuing device according to claim 4, wherein the ticket issuing channel is configured to transport the lottery-tickets obliquely downwards towards the guide surface through the ticket exit port.

6. The lottery-ticket issuing device according to claim 1, wherein the second base frame comprises a box body and a door body, the box body has an output port, the door body is movably connected to the box body and is configured to open or close the output port, when the door body closes the output port, the door body and the box body jointly form the ticket receiving cavity, and an inner side surface of the door body and/or an inner side surface of the box body form the guide surface.

7. The lottery-ticket issuing device according to claim 6, wherein the inner side surface of the door body forms the guide surface, a bottom surface of the box body and the inner side surface of the box body jointly form the supporting surface, the box body is further provided with an elongated hole, and the elongated hole extends from the inner side surface of the box body to the output port via the bottom surface of the box body.

8. The lottery-ticket issuing device according to claim 1, wherein the first base frame further has a first guide surface and a second guide surface, the ticket issuing channel further has a ticket entry port, the ticket issuing mechanism further comprises a reversing member rotatably disposed on the first base frame, the reversing member is located between the first guide surface and the second guide surface, and the reversing member has a third guide surface and a fourth guide surface which face away from each other; and
the reversing member is locatable between a first position and a second position when the reversing member rotates relative to the first base frame, when the reversing member is located in the first position, the third guide surface and the first guide surface are opposite to each other and are arranged at intervals, a ticket entry channel communicating with the ticket entry port is formed between the third guide surface and the first guide surface, and the ticket entry channel is configured to input the lottery-tickets into the ticket issuing channel; when the reversing member is located in the second position, the fourth guide surface and the second guide surface are opposite to each other and disposed at intervals, a recycling channel communicating with the ticket entry port is formed between the fourth guide surface and the second guide surface, and the recycling channel is configured to receive the lottery-tickets returned from the ticket issuing channel.

9. A lottery-ticket vending machine, comprising:
a cabinet provided with a ticket pickup port for outputting a lottery-ticket;
a ticket exit device disposed within the cabinet and configured to store and output the lottery-ticket; and
the lottery-ticket issuing device of claim 1, wherein the lottery-ticket issuing device is movably disposed within the cabinet and has a ticket receiving position and a ticket pickup position, when the lottery-ticket issuing device is located in the ticket receiving position, the ticket issuing mechanism is capable of being opposite to the ticket exit device to receive the lottery-ticket output by the ticket exit device; when the lottery-ticket issuing device is located in the ticket pickup position, the ticket receiving mechanism is opposite to the ticket pickup port to output the lottery-ticket within the ticket receiving cavity through the ticket pickup port.

10. A lottery-ticket vending machine, comprising:
a cabinet provided with a ticket pickup port for outputting a lottery-ticket;
a ticket exit device disposed within the cabinet and configured to store and output the lottery-ticket;
the lottery-ticket issuing device of claim 8, wherein the lottery-ticket issuing device is disposed within the cabinet, the ticket issuing mechanism is configured to receive the lottery-ticket output by the ticket exit device, and the ticket receiving cavity is capable of communicating with the ticket pickup port to output the lottery-ticket through the ticket pickup port; and
a recycling box disposed within the cabinet and having a recycling port, wherein the recycling port is capable of communicating with the recycling channel to receive the lottery-ticket output by the recycling channel.

11. The lottery-ticket issuing device according to claim 2, wherein the second base frame comprises a box body and a door body, the box body has an output port, the door body is movably connected to the box body and is configured to open or close the output port, when the door body closes the output port, the door body and the box body jointly form the ticket receiving cavity, and an inner side surface of the door body and/or an inner side surface of the box body form the guide surface.

12. The lottery-ticket issuing device according to claim 3, wherein the second base frame comprises a box body and a door body, the box body has an output port, the door body is movably connected to the box body and is configured to open or close the output port, when the door body closes the output port, the door body and the box body jointly form the ticket receiving cavity, and an inner side surface of the door body and/or an inner side surface of the box body form the guide surface.

13. The lottery-ticket issuing device according to claim 4, wherein the second base frame comprises a box body and a door body, the box body has an output port, the door body is movably connected to the box body and is configured to open or close the output port, when the door body closes the output port, the door body and the box body jointly form the ticket receiving cavity, and an inner side surface of the door body and/or an inner side surface of the box body form the guide surface.

14. The lottery-ticket issuing device according to claim 5, wherein the second base frame comprises a box body and a door body, the box body has an output port, the door body is movably connected to the box body and is configured to open or close the output port, when the door body closes the output port, the door body and the box body jointly form the ticket receiving cavity, and an inner side surface of the door body and/or an inner side surface of the box body form the guide surface.

15. The lottery-ticket issuing device according to claim 2, wherein the first base frame further has a first guide surface and a second guide surface, the ticket issuing channel further has a ticket entry port, the ticket issuing mechanism further comprises a reversing member rotatably disposed on the first base frame, the reversing member is located between the first guide surface and the second guide surface, and the reversing member has a third guide surface and a fourth guide surface which face away from each other; and
the reversing member is locatable between a first position and a second position when the reversing member rotates relative to the first base frame, when the reversing member is located in the first position, the third guide surface and the first guide surface are opposite to each other and are arranged at intervals, a ticket entry channel communicating with the ticket entry port is formed between the third guide surface and the first guide surface, and the ticket entry channel is configured to input the lottery-tickets into the ticket issuing channel; when the reversing member is located in the second position, the fourth guide surface and the second guide surface are opposite to each other and disposed at intervals, a recycling channel communicating with the ticket entry port is formed between the fourth guide surface and the second guide surface, and the recycling channel is configured to receive the lottery-tickets returned from the ticket issuing channel.

16. The lottery-ticket issuing device according to claim 3, wherein the first base frame further has a first guide surface and a second guide surface, the ticket issuing channel further has a ticket entry port, the ticket issuing mechanism further comprises a reversing member rotatably disposed on the first base frame, the reversing member is located between the first guide surface and the second guide surface, and the reversing member has a third guide surface and a fourth guide surface which face away from each other; and
the reversing member is locatable between a first position and a second position when the reversing member rotates relative to the first base frame, when the reversing member is located in the first position, the third guide surface and the first guide surface are opposite to each other and are arranged at intervals, a ticket entry channel communicating with the ticket entry port is formed between the third guide surface and the first guide surface, and the ticket entry channel is configured to input the lottery-tickets into the ticket issuing channel; when the reversing member is located in the second position, the fourth guide surface and the second guide surface are opposite to each other and disposed at intervals, a recycling channel communicating with the ticket entry port is formed between the fourth guide surface and the second guide surface, and the recycling channel is configured to receive the lottery-tickets returned from the ticket issuing channel.

17. The lottery-ticket issuing device according to claim 4, wherein the first base frame further has a first guide surface and a second guide surface, the ticket issuing channel further has a ticket entry port, the ticket issuing mechanism further comprises a reversing member rotatably disposed on the first base frame, the reversing member is located between the first guide surface and the second guide surface, and the reversing member has a third guide surface and a fourth guide surface which face away from each other; and
the reversing member is locatable between a first position and a second position when the reversing member rotates relative to the first base frame, when the reversing member is located in the first position, the third guide surface and the first guide surface are opposite to each other and are arranged at intervals, a ticket entry channel communicating with the ticket entry port is formed between the third guide surface and the first guide surface, and the ticket entry channel is configured to input the lottery-tickets into the ticket issuing channel; when the reversing member is located in the second position, the fourth guide surface and the second guide surface are opposite to each other and disposed at intervals, a recycling channel communicating with the ticket entry port is formed between the fourth guide surface and the second guide surface, and the recycling channel is configured to receive the lottery-tickets returned from the ticket issuing channel.

18. The lottery-ticket issuing device according to claim 5, wherein the first base frame further has a first guide surface and a second guide surface, the ticket issuing channel further has a ticket entry port, the ticket issuing mechanism further comprises a reversing member rotatably disposed on the first base frame, the reversing member is located between the first guide surface and the second guide surface, and the reversing member has a third guide surface and a fourth guide surface which face away from each other; and
the reversing member is locatable between a first position and a second position when the reversing member rotates relative to the first base frame, when the reversing member is located in the first position, the third guide surface and the first guide surface are opposite to each other and are arranged at intervals, a ticket entry channel communicating with the ticket entry port is formed between the third guide surface and the first guide surface, and the ticket entry channel is configured to input the lottery-tickets into the ticket issuing channel; when the reversing member is located in the second position, the fourth guide surface and the second guide surface are opposite to each other and disposed at intervals, a recycling channel communicating with the ticket entry port is formed between the fourth guide surface and the second guide surface, and the recycling channel is configured to receive the lottery-tickets returned from the ticket issuing channel.

19. The lottery-ticket vending machine according to claim 9, wherein the supporting surface comprises a first surface and a second surface disposed at an obtuse angle from the first surface, the first surface is configured to support front ends of the lottery-tickets, and the second surface is configured to support surfaces of the lottery-tickets.

20. The lottery-ticket vending machine according to claim 19, wherein the guide surface is a vertical plane, the first surface is arranged to be perpendicular to the guide surface, the second surface and the guide surface are opposite to each other and arranged at intervals, and the guide surface is configured to guide the lottery-tickets output from the ticket issuing channel to move vertically downward and to be stacked on the first surface and the second surface in a horizontal direction.
